(19) United States
(12) Patent Application Publication
(10) Pub. No.: US 2010/0019468 A1
(43) Pub. Date: Jan. 28, 2010

(54) APPARATUS, SYSTEM AND METHOD FOR ACCESSING THE ENGINE COMPARTMENT OF A VEHICLE

(76) Inventor: L. Jay Price, Salt Lake City, UT (US)

Correspondence Address: Kunzler & McKenzie, 8 EAST BROADWAY, SUITE 600, SALT LAKE CITY, UT, 84111, US

(21) Appl. No.: 12/488,415

(22) Filed: Jun. 19, 2009

Related U.S. Application Data
(60) Provisional application No. 61/074,613, filed on Jun. 21, 2008.

(51) Int. Cl. B60R 3/00; E04G 3/28

(52) U.S. Cl. 280/165; 182/150

(57) ABSTRACT

An apparatus, system and method system are disclosed for supporting a user to facilitate accessing components in an elevated engine compartment. An apparatus for supporting a user to facilitate accessing components in an engine compartment has a platform for supporting a user and for resting on a tire. The apparatus also has a downward protrusion extending downward from the platform and having one or more steps.

### CROSS-REFERENCES TO RELATED APPLICATIONS

This application claims priority to U.S. Provisional Patent Application No. 61/074,613 entitled “Portable Service Accessory for a Truck Tractor” and filed on 21 Jun. 2008 for Jay Price, which is incorporated herein by reference.

### BACKGROUND

1. Field of the Invention

This invention is in the field of ladders and is more specifically directed at providing safe access to truck tractor engine compartments.

2. Description of the Related Art

Maintenance of truck tractors is extremely important to their being able to function hour after hour and day after day as they constantly haul freight from location to location. Checking engine fluids, brakes, various engine components and even tire pressure frequently can keep a truck tractor running smoothly and help a user to anticipate needed services. This in turn allows freight to remain on the move and avoids dangers to the driver and damage to the expensive truck tractor. Keeping freight on the move, safety high, and damages to trucks at a minimum can save commercial and private trucking companies considerable sums of money.

Because of the importance of maintenance and inspection of these important and expensive vehicles drivers, mechanics, and even government inspectors need repeated and frequent access to the engine compartment of truck tractors. However, truck tractors, unlike many consumer vehicles, have engine compartments that are quite difficult to access. The engines for such truck tractors are often elevated several feet off of the ground and accessing upper portions of the engine is often impossible from the ground. Conventionally, drivers, mechanics and inspectors must climb onto a frame of the truck to be able to see much of the engine or perform important tasks. Because the frame is generally several feet of the ground, they must use bumpers, lug-nuts, wheels and/or tires as footholds to climb up onto the frame. These footholds are extremely insecure and subject the individual to injury while climbing.

Furthermore, an individual must generally maintain his or her balance by grabbing various components with his or her hands due to poor footholds. This can be quite dangerous because of various moving and hot components parts. All in all, in the present state of the art, it is inconvenient and hazardous to gain access to numerous important components of a truck tractor for inspection or servicing. Although such dangers and inconveniences are common to truck tractors, they are applicable to many vehicles and particularly those with elevated engine compartments.

### SUMMARY

From the foregoing discussion, it should be apparent that a need exists for an apparatus and system that allows an individual to gain convenient and safe access to a truck tractor engine compartment. Beneficially, such an apparatus and system would be easy to use and provide a simple way of climbing to a height sufficient to perform needed inspection and service.

The present invention has been developed in response to the present state of the art, and in particular, in response to the problems and needs in the art that have not yet been fully solved. Accordingly, the present invention has been developed to provide an apparatus, system, and method for accessing an elevated engine compartment that overcome many or all of the above-discussed shortcomings in the art.

The apparatus to access an elevated engine compartment of a vehicle is provided with a platform having a first end and a second end, wherein a downward protrusion is attached to the second end, the downward protrusion having one or more steps and wherein the platform is configured to engage a tire of the vehicle for support.

The downward protrusion, in one embodiment, further comprises a support member extending downward from the platform to engage an external surface for support. The platform depth may be large enough to span a tire. The platform may also be substantially larger than the steps.

According to another embodiment, the downward protrusion is collapsible. For example, the downward protrusion is collapsible by means of one or more joints which allow the protrusion to fold against the platform. Alternatively, the downward protrusion collapses to substantially within the dimensions of the platform.

According to another embodiment, the platform comprises a joint along which the platform can fold. The platform may also comprises a slidable member. The platform may also be configured to engage a frame of the vehicle for support. The platform may engage a frame of the vehicle via one or more hinges.

According to another embodiment of the invention, the downward protrusion is configured to engage a ground surface. The downward protrusion may also be configured to engage one of a tire and a wheel of the vehicle. The invention may comprise a bumper that extends from a handrail to engage one of the tire and the wheel of the vehicle.

According to another embodiment, the downward protrusion comprises a first rail and a second rail with the one or more steps extending between the first rail and the second rail. The apparatus may further comprise latches to selectively secure the platform in one of an extended position or a collapsed position.

According to an alternate embodiment, an apparatus for supporting a user, has a platform having a first end and a second end, wherein the first end is configured to attach to a structural component of the vehicle and wherein the platform comprises a slidable member. The apparatus further comprises a downward protrusion attached to the second end of the platform, the downward protrusion having one or more steps, wherein the downward protrusion folds under the slidable member of the platform.

A system of the present invention is also presented to provide access to an elevated engine compartment of a vehicle. The system may be embodied by a vehicle having a tire and an elevated engine compartment adjacent to the tire. The apparatus is provided with a platform wherein a downward protrusion is attached to and extends downward from the platform, the downward protrusion having one or more steps and wherein the platform is configured to engage the tire of the vehicle for support.

A method of the present invention is also presented to provide access to an elevated engine compartment. The method, according to one embodiment, comprises providing a vehicle having a tire and an elevated engine compartment adjacent to the tire, an apparatus for supporting a user, the apparatus comprising: a platform for supporting a user and for resting on the tire for support; and a downward protrusion extending downward from the platform, the downward protrusion having one or more steps. The method further comprises placing the platform over the tire with the tire supporting the platform. The method may further comprises providing an apparatus having a collapsible downward protrusion, wherein the downward protrusion is collapsed. The method may also comprises converting the downward protrusion from a collapsed position to an extended position before placing the platform over the tire. The method may also further comprises removing the platform from over the tire and converting the downward protrusion from the extended position to the collapsed position.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of an engine compartment ladder that engages both the truck tractor frame and tire, according to one exemplary embodiment of the principles disclosed herein;

FIG. 2 is a perspective view of the engine compartment ladder of FIG. 1 in collapsed position, according to one exemplary embodiment of the principles disclosed herein;

FIG. 3 is a perspective exploded view of the engine compartment ladder of FIG. 1, according to one exemplary embodiment of the principles disclosed herein;

FIG. 4 is a perspective view of an engine compartment ladder which engages a truck tractor tire, according to one exemplary embodiment of the principles disclosed herein;

FIG. 5 is a perspective view of the engine compartment ladder of FIG. 4 in collapsed position, according to one exemplary embodiment of the principles disclosed herein.

FIG. 6 is a perspective view of an engine compartment ladder, according to one exemplary embodiment of the principles disclosed herein.

FIG. 7 is a perspective view of the engine compartment ladder of FIG. 6 in collapsed position, according to one exemplary embodiment of the principles disclosed herein.

FIG. 8 is an elevation view of the engine compartment ladder of FIG. 6 with optional legs, according to one exemplary embodiment of the principles disclosed herein.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The engine compartment ladder disclosed herein facilitates ease of access to elevated engine compartments on vehicles. Elevated engine compartments are most commonly known in the art in relation to truck tractors which are used to pull semi-trailers and haul large amounts of freight or other goods and materials. However, other difficult to reach engine compartments are available on other vehicles as well. The apparatus, system, and method herein apply to both conventional truck tractors and other vehicles with inaccessible or elevated engine compartments.

Various embodiments of the present invention depend for support on different components of truck tractors. These components include tires, frames, or other structural elements. Various modifications will be applicable to each embodiment depending on its desired mounting location, portability, stability, and load bearing capability. For example, embodiments which depend on a tire and a truck frame for support must be mountable near the tire.

As will be clear to one skilled in the art, engine compartment shapes and configurations vary between truck model and year. Thus, shapes, sizes and mounting procedures may vary accordingly. Platforms may take a variety of shapes and sizes limited only by the target engine compartment. On the other hand, embodiments which are mounted only to the tire may be much more versatile in terms of the models of trucks with which it is compatible. Many additional details will be mentioned herein or will be apparent to one skilled in the art in relation to the configurations and examples given.

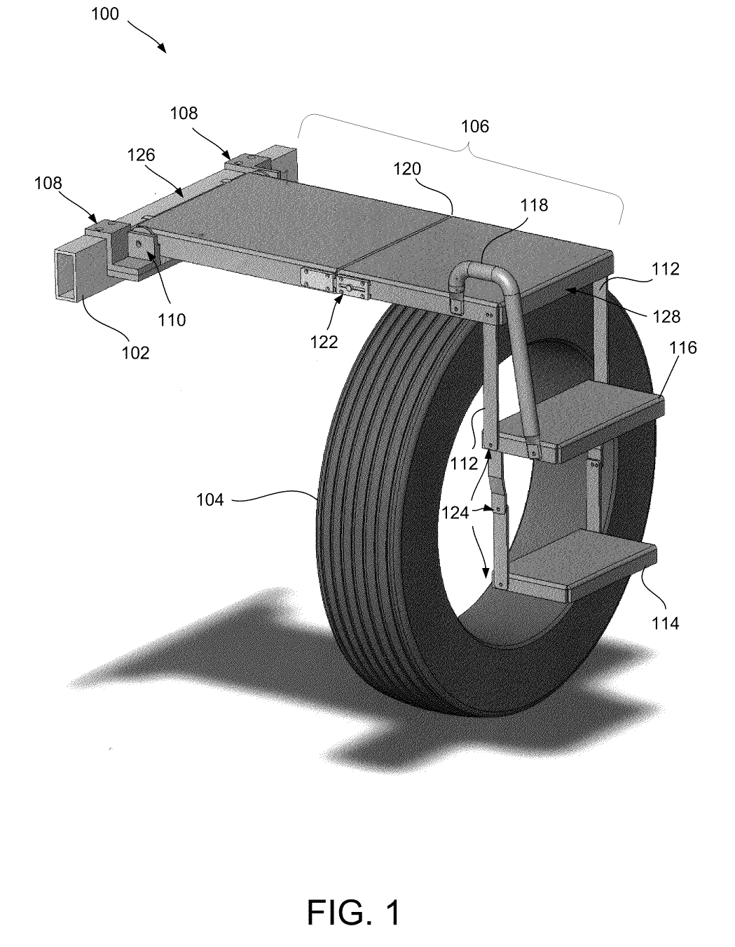

With regard to FIG. 1, a perspective view of an engine compartment ladder 100 is shown. The ladder 100 is shown with engine compartment frame 102 and vehicle tire 104 to show the orientation of the ladder 100 when installed in a truck tractor engine compartment. The engine compartment ladder 100 comprises a platform 106 with a joint 120 and a sliding latch 122. The platform 106 has a first end 126 attached to the frame 102 via brackets 108 and hinges 110. A second end 128 of the platform 106 is attached to a downward protrusion comprising rails 112, a first step 114, a second step 116, and a handrail 118.

The platform is shown cantilevered from the first end 126 over the tire 128 and supported by the tire. According to one exemplary embodiment, the brackets 108 and hinges 110 on the first end 126 are not strong enough to support the weight of the platform 106 and a user and thus the platform rests on the tire 104 for support. The platform has a width distance approximately the distance between the rails 112. The platform has a depth distance from the first end 126 to the second end 128. The depth of the platform 106, according to one exemplary embodiment, is from ten inches to three feet. According to another embodiment, the platform 106 depth is from 12 inches to 3 feet. A further embodiment has a platform 106 depth of from 16 inches to 3 feet.

The handrail 118 shown is attached to the platform 118 at one end and the second step 116 at the other end. The handrail 118 initially extends upward from the platform 106 and then curves downward. It will be understood that the handrail 118 may be attached to the platform 106 at both ends and that its shape and length can vary greatly. Furthermore, a handrail 118 may be positioned on either side of the steps 114, 116 or on both sides.

The downward protrusion in its simplest form, when the ladder is in its extended position as shown, extends generally downward from the platform 106 and comprises at least one step. It may further comprise rails 112 and handrails 118 as shown. It will be understood that although the downward protrusion extends generally downward, it can also extend laterally away from the platform 106 or may extend upward a certain distance, as is illustrated by the handrail 118. The direction and distance to which the protrusion extends will be generally to facilitate the climbing of a user up to the platform 106.

The steps 114, 116 have a solid sheet on which a user may step to climb to the platform 106. As will be understood by one skilled in the art, the steps 114, 116 may take a variety of forms and serve a similar purpose in a satisfactory manner. For example, instead of solid sheets on which a user may step, the steps 114, 116 may comprise a mesh or diamond cut surface. A diamond cut surface may be desirable for gripping or may be lighter than a solid sheet. Furthermore a diamond cut surfaced may allow dirt, grime, water, snow, and the like to fall through keeping the ladder 100 clean and allowing a user's feet to directly grip the steps 114, 116. Other variations include rungs similar to those on a ladder, horizontal rods, or a plurality of other replacements.

The platform 106 is supported by the frame 102 at the first end 126 and rests on the tire 104 near the second end 128. The brackets 108 and hinges 110 are sufficiently strong to bear the weight of a user. The brackets 108 are shown bolted to the frame 102. It will be understood by one skilled in the art that the brackets 108 shown may be replaced by a plurality of mechanisms to maintain the platform 106 against the frame 102. For example, flanges under the platform 106 may be used to allow the platform 106 to rest securely on the frame. Alternatively, hooks or roods may extend off the first end 126 of the platform 106 to operate in a similar manner. Preferably, the attachment mechanism, similar to the brackets 108 and hinges 110 shown, will allow the platform 106 to remain attached to the frame 102 and still allow the platform 106 to rotate from a horizontal to a vertical position.

The second end 128 of the platform 106 supports the rails 112 and handrail 118 which in turn support the steps 114 and 116. The second step 116 is shown supported by both the rails 112 and the handrail 118. The first step 114 is shown supported solely by the rails 112. The rails 112 and handrail 118 provide rigidity to the position of the steps 114, 116 so that they can securely bear the weight of a user. According to one exemplary embodiment, the steps are configured to bear up to 500 lbs.

The rails 112 shown in FIG. 1 comprise a plurality of flat elongated rods. These rails 112 may take a variety of forms. For example the rails 112 may also comprise round elongated rods, tubes, telescoping poles or, in some embodiments may comprise cables which are used to hang the steps 114, 116. The rails 112 may also comprise a greater number or smaller number of rods than are shown in FIG. 1.

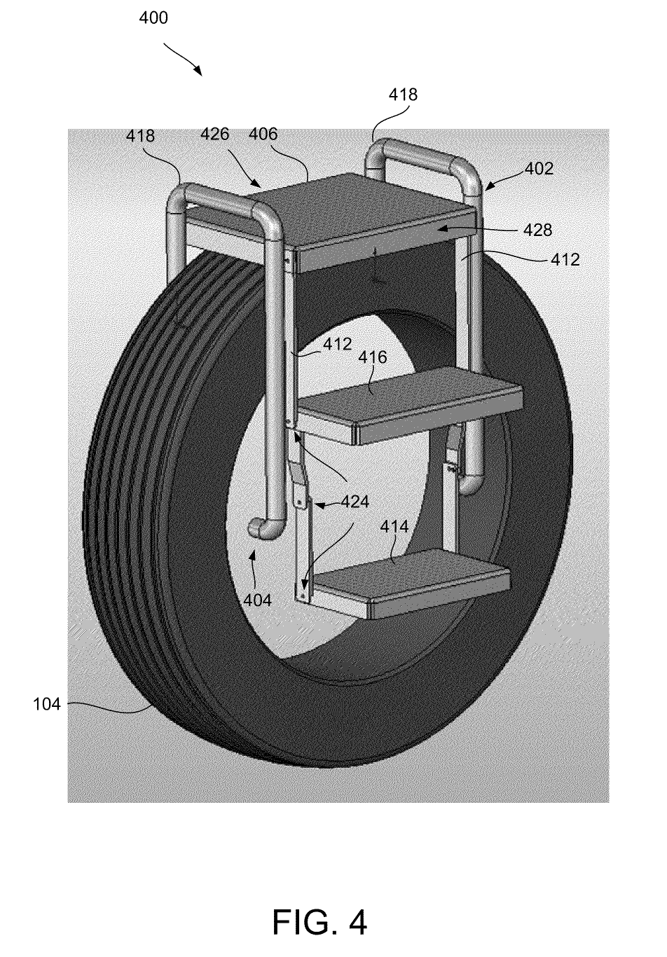

It will be clear to one skilled in the art that the second step 116 may be supported by the rails 112 only or that the first step 114 may also be supported by the handrail 118. Many different configurations will suffice in providing the needed rigidity and strength. According to one exemplary embodiment, not shown in FIG. 1, the rails 112 or handrail 118 may provide a bumper (similar to bumper 404 of FIG. 4) that will engage the side of the tire 104 or wheel (not shown). The bumper would provide additional support to the handrail 118 which in turn would provide additional support to whatever it is attached, such as the second end 128 of the platform 106 or the steps 114 and/or 116.

According to another alternate embodiment an additional rail member (not shown) may run at an angle between the rails 112 and the steps 114, 116 for additional support. A further exemplary embodiment provides legs under the first step 114 that reach to the ground. Such legs may have joints for folding and/or be telescopic in nature such that their length can be adjusted.

The engine compartment ladder 100 shown is configured to collapse when not in use such as for travel and/or when an engine compartment cover is shut. In FIG. 1, the platform 106 is shown in an extended position. The platform 106 is extended at the joint 120 with the sliding latch 122 engaged to hold it in an extended position. The sliding latch 122 provides security but may not be necessary in certain embodiments. The platform 106 may also be folded along the joint 120 for storage. The rails 112 and steps 114, 116 are shown with a plurality of joints 124 which allow them to fold underneath the platform 106. The handrail 118 may detach from the second step 116 to allow it to fold. The handrail 118, according to one exemplary embodiment, may further rotate along a joint to make the ladder flatter when in a collapsed position.

To fold, according to one exemplary embodiment, the second end 128 of the platform may be lifted, with the first end 126 pivoting along the hinges 110. While lifted, the rails 112 and steps 114, 116 may be folded underneath the platform. The platform may then fold at the joint 120, folding the ladder 100 into a small flat unit. According to one exemplary embodiment, the downward protrusion collapses to within the dimensions of the platform 106. The ladder 100 can then be oriented vertically allowing the tire 114 to rotate freely for travel and the engine compartment cover to be secured shut.

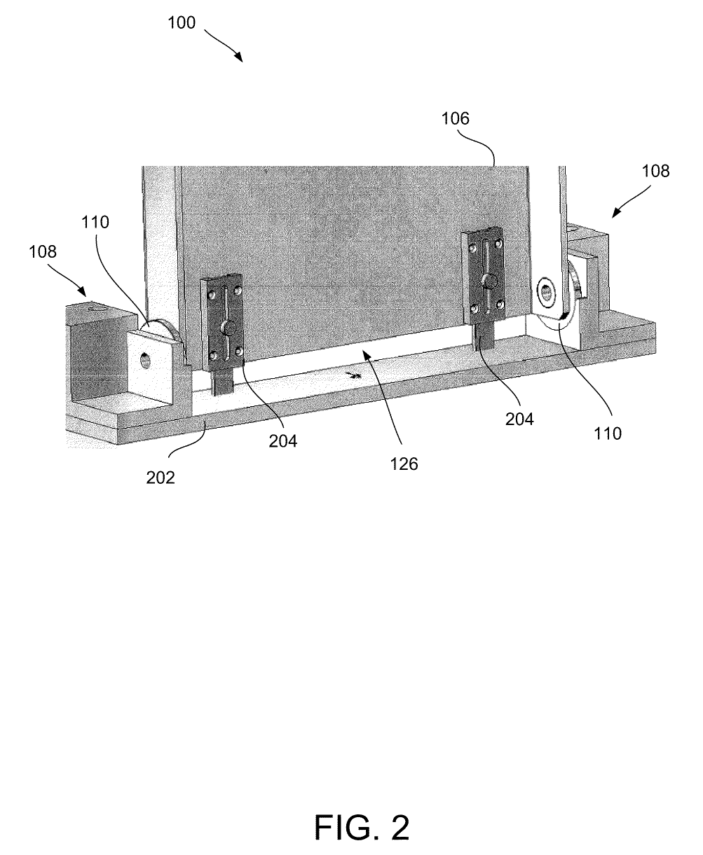

FIG. 2 shows a close up perspective view of the first end 126 of the ladder 100 when the ladder is folded and oriented vertically. In FIG. 2 the underside of the first end 126 of the platform 106 is shown with hinges 110 and brackets 108. The joint 120, steps 114 and 116, rails 112, and handrail 118 are not shown. The hinges 110 can take a variety of forms. For example, the hinges 110 may comprise a hole and pin or even ball bearings.

A horizontal stabilizing bar 202 is shown attached to both brackets 108. Previously obscured sliding latches 204 are shown. According to an exemplary embodiment, the sliding latches 204 can engage the horizontal stabilizing bar 202 to hold the platform in a vertical position. According to another exemplary embodiment, the latches 204 can also engage the frame, 102 of FIG. 1, to hold the platform in an extended position. The latches 122, 204 shown are exemplary only and may be replaced a plurality of other mechanisms. The platform 106 may also be held in an extended position with similar latches, hooks, or the like which allow a user to selectively fix the platform in a desired position.

When extended the platform 106 of FIGS. 1 and 2 provide a large stable work area whereon a user can stand, sit, or kneel to inspect or work on components in the engine compartment. The large area of the platform 106 increases safety and reduces the risk of a fall for a user. The platform 106 is shown with constant width from the first end 126 to the second end 128. As will be understood by one skilled in the art, the platform may take a variety of shapes. According to one exemplary embodiment the platform 106 has a T-shape with the first end 126 much wider than the second end 128.

Similar to the variations as discussed above in relation to the steps, the platform may also comprise a mesh rather than a solid sheet or any number of other variations. Rather than a solid sheet as shown, the platform may comprise a plurality of horizontal rods upon which a user can stand. The present invention is not meant to be restricted to the solid sheet configuration for the platform 106 as shown.

The solid sheet platform 106 and step 114, 116 surfaces may be configured as non-skid surfaces to reduce the likelihood of slipping and/or falling. Types of surfaces that may be used include, but are not limited to knolling, bumps, or other textures built into or attached to the steps 114, 116 and platform 106. For example, the surface of the platform 106 and steps 114, 116 may be covered with adhesive non-skid tape or the surfaces may be machined to have non-skid surfaces.

To gain access to the engine compartment, a user may climb onto the platform 106 very easily by using the steps 114, 116 and handrail 118. As previously discussed, the steps 114, 116 are sturdy to provide ample support for even very large individuals. The latches 122 and 202 securely hold the platform in the desired position.

The platform 106 supported by the tire 104 provides considerable support and working area with very little materials or mechanical complication. With the platform 106 located over the tire 104 a user gains central and easy access to the engine compartment making it quite easy to access a large number of important components.

The ladder 100 is very convenient because it can be stored under the engine compartment cover and does not require additional storage area. It can be mounted once and always be available for use. Conversion from the collapsed position to the extended position is simple and quick, as is conversion from the extended position to the collapsed position. The use of the ladder is convenient enough that it can be used for even the most trivial inspections of engine compartment components without increasing the time needed to do so.

The platform 106 of FIGS. 1 and 2 may built into the engine compartment during the manufacture of a truck tractor or may be installed as an after-market addition. The brackets 108, for example, may be welded onto the frame or the frame may be manufactured with brackets. It will be understood that the brackets can vary considerably between tractors due to different sizes and shapes of the frame 102 on different models and truck sizes.

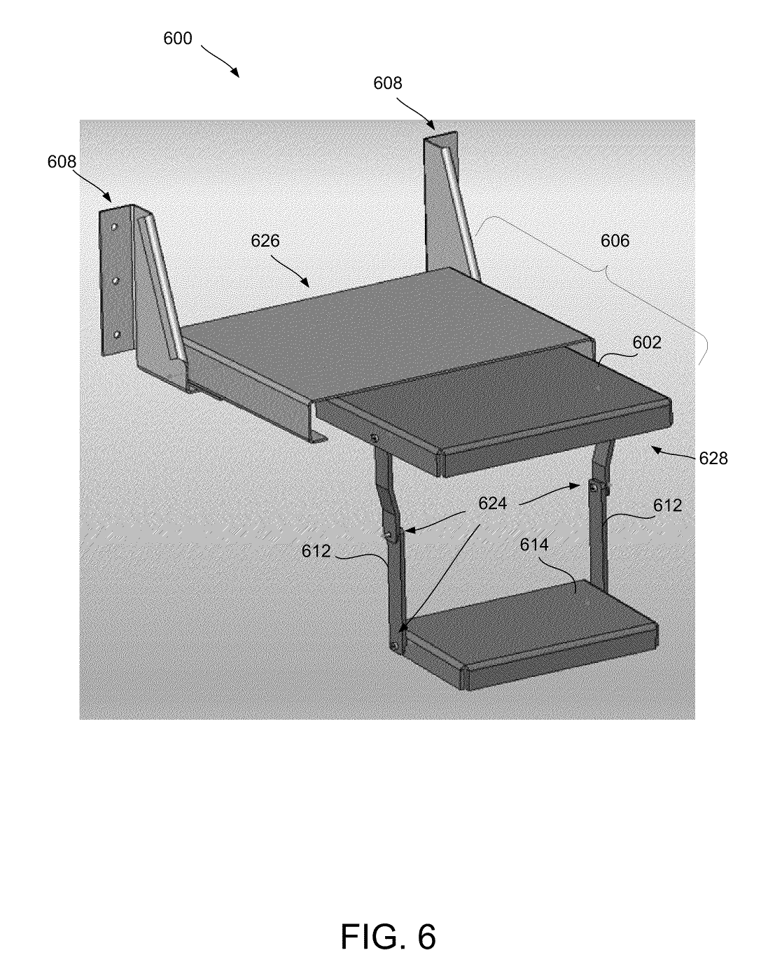

As will be appreciated by one skilled in the art there is considerable variation that can be made in keeping with the teaching of the embodiment of FIGS. 1 and 2. For example, instead of a joint 120 which allows the platform 106 to fold, the platform may alternatively have no joints and not be collapsible. Alternatively the platform 106 with joint 120 could be replaced by a platform with a sliding member similar to that shown in FIG. 6.

The ladder 100 and components are made of material sufficiently strong to support the weight of a user and to withstand repeated use. Further, the components will preferably be made of materials that are both light and strong. Reduced weight will make use of the ladder 100 easier and will provide other benefits such as reduced gas mileage. Examples of materials which may meet these requirements include, but are by no means limited to, metals such as aluminum and steel, composite materials, or wood. Even plastics and rubbers may be sufficiently rugged for certain parts of the ladder.

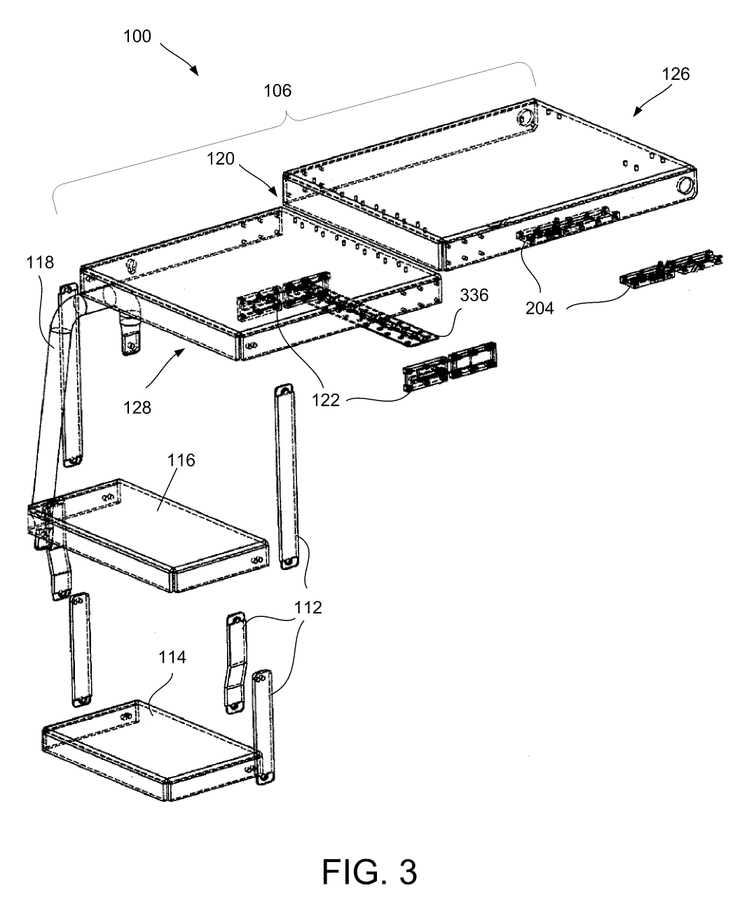

FIG. 3 shows an exploded perspective view of the engine compartment ladder 100 of FIG. 1. This figure illustrates the assembly of the ladder and provides additional detail for its separate components. The brackets 108, hinges 110, and horizontal stabilizing bar 202 are not shown. The platform 106 is shown prior to attachment along joint 120. According to one exemplary embodiment, the platform 106 is attached along joint 120 with a hinge 336. The hinge 336 allows the platform to act as one solid piece of material while still allowing it to fold along the joint 120 for storage.

It will be understood that the teaching in relation to the embodiments of FIGS. 1-3 apply, without limitation, to the teaching and embodiments of the remaining figures.

With regard to FIG. 4 a perspective view of an alternate engine compartment ladder 400, according to one exemplary embodiment, is shown. The engine compartment ladder 400 is shown mounted to the tire 104 for orientation. A key difference between the ladder 400 and that of FIGS. 1-3 is that the ladder 400 does not engage the frame of the truck tractor. The engine compartment ladder 400 comprises a platform 406 and a downward protrusion having rails 412, a first step 414, and a second step 416. The ladder 400 also has handrails 418.

A first end 426 of the platform 406 is facing towards the interior of the vehicle with the second end 428 facing to the exterior of the vehicle. The depth of the platform is the distance between the first end 126 and the second end 128. The depth of the platform is large enough to span the width of the tire of a vehicle. The depth of the platform 406, according to one exemplary embodiment, is from ten inches to three feet. According to another embodiment, the platform 406 depth is from 12 inches to 3 feet. A further embodiment has a platform 406 depth of from 16 inches to 3 feet. The platform 406 is attached at the second end 428 to a downward protrusion having rails 412 and steps 414 and 416. The handrails 418 are attached to the rails 412 and platform 426 near the first end 426 of the platform and removably attached to the platform 406 at the second end 428. The handrails 418 may be removably attached to the platform 406 by a variety of mechanisms.

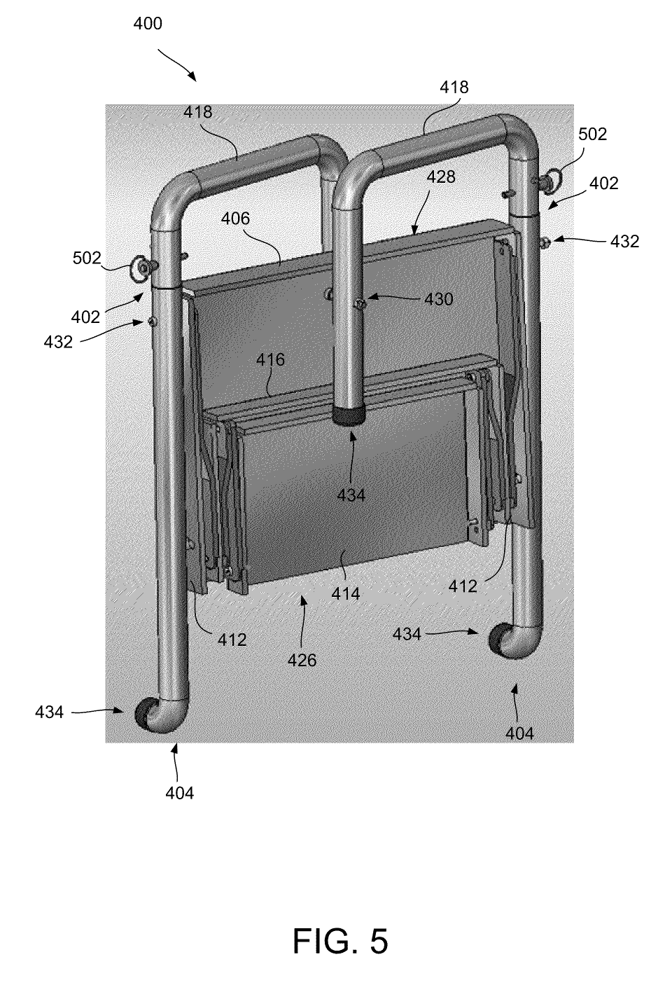

According to one exemplary embodiment a pin or other feature, not shown, protrudes from the handrails 418 on which the platform 406 at the first end 426 rests. According to another exemplary embodiment, a nut and bolt 430, as shown in FIG. 5, may be used to attach the handrails to the platform 406 at the first end 426. The nut may be a convention hex nut or a wing nut for easy application and removal by hand. A further embodiment makes use of a spring biased pin which is biased to extend through a hole or groove near the first end 426 of the platform 406.

The rail 412 and step 414, 416 configuration is very similar to that shown in FIG. 1. The steps 414, 416 are supported by the rails 412. However, the handrails 418, in this embodiment, do not engage either of the steps 414, 416. It will be clear to one skilled in the art that the rail 412 and step 414, 416 configuration may vary as discussed in relation to FIG. 1. The handrails 418, in some embodiments, may engage one or both of the steps 414, 416.

The handrails 418 have an added feature which provides support to the ladder. The bumpers 404 extend from the handrails 418 towards the tire 104 to engage the tire 104 or wheel of the vehicle. For example, the platform 406 is narrow enough that the handrails 418 can engage the rim of the wheel (not shown). In an alternate embodiment, the handrails 418 extend farther towards the ground to engage the lower portion of the tire 104. Either embodiment provides support to prevent the ladder 400 from rotating in the direction of the steps 414, 416 when a user climbs the ladder 400 or stands on the platform 406.

With wider platforms 406 the handrails 418 may be widely set such that the bumpers 404 would engage the sides of the tire 104. The width of the platform 406 can vary but the stability of the platform 406 should be taken into account. If the platform 406 is too wide, the tire 104 which is of limited width cannot provide sufficient lateral support. As previously mentioned, bumpers 404 may be added on the embodiment of FIG. 1 or other embodiments without limitation.

As will be shown in FIG. 5, the handrails 418 are attached to both the rails 414 and the platform with a bolt. According to one exemplary embodiment, the handrails 418 are only attached to the platform 406. According to another exemplary embodiment, the handrails provide support to the rails 412 to hold the steps 414, 416 more rigidly. Other embodiments provide variations on the rails 412 and steps 414, 416 to provide support for a user.

The ladder 400 is used similarly to the ladder 100 of FIGS. 1 and 2. A user may climb the steps 414, 416 to the platform 406. From the platform 406, the user may inspect or service components in the engine compartment. Because the platform 406 is smaller than the platform 106 of FIG. 1, a user may also use the ladder 400 to be able to easily step to a frame component, or other platform mounted to the frame such as a catwalk (not shown), mounted to the frame (see frame 102 of FIG. 1). Even if there is not an additional platform mounted to the frame, the ladder 400 makes it much easier for a user to get to the frame because the frame is generally approximately as high as the platform 406 which can be several feet of the ground, depending on the vehicle. Stepping from the ground to such a height is generally quite difficult for a user.

The ladder 400 also collapses for storage, similar to the ladder embodiment 100 of FIG. 1. The hand rail 418 can be disconnected from the first end 426 of the platform 406 allowing the platform 406 to swing down parallel to the rails 412. The rails 412 and steps 414, 416 have joints 424 which allow them to fold underneath the platform 406. The handrails 418 are allowed to pivot along joints 402. The components of the collapsed ladder 400 in a folded position lie largely along the same plane. According to one exemplary embodiment, the steps 414, 416 collapse to within the dimensions of the dimensions of the platform 406. The ladder 400 in removed from the tire 104 and in folded position is illustrated in FIG. 5.

With regard to FIG. 5 a perspective view of the ladder 400 of FIG. 4 is shown in collapsed position. The handrails 418, platform 406, steps 414 and 416, and rails 412 are collapsed into largely the same plane. The rails 412 are shown folded consecutively under the platform 416 with the steps 416. The undersides of the platform 406 and steps 414, 416 are visible. The platform 406 is shown attached using bolts 432 to the rails 412 and handrails 418 at the second end 428. The handrails 418 and rails 412 are allowed to pivot relative to the platform 406 at the bolts 432.

The upper portion of the handrails 418, have been pivoted along joints 402 to rotate up flat against the platform 406. According to one exemplary embodiment pins 502 can be inserted into the hand rails 418 near the joints 402 to hold the hand rails in, selectively, a collapsed or extended position. A plurality of caps 434 are shown on the ends of the handrails 418. These caps 434 help protect the tire 104 from what may be sharp ends on the handrails 418. Furthermore, the caps 434 may help provide increased friction between the tire 104 and bumpers 404 to hold the ladder 400 in place on the tire 104.

The tire mounted engine compartment ladder 400 is very portable. By using the tire 104 of a vehicle the ladder is very steady and safe for its small size and limited bulk. It can be quickly converted from a collapsed position (FIG. 5) to an extended position (FIG. 4) and then back again. The ladder 400 can also be easily carried by a single person such as by holding onto the hand rails 418. Variations on the materials used for the ladder 400 will make for a lighter or heavier load to carry. For example, a ladder 400 made primarily of aluminum will be much lighter than a ladder 400 made primarily of steel.

The tire mounted engine compartment ladder 400 is very versatile in that it can be mounted on driver's side or passenger's side of a truck tractor with no installation time, unlike the embodiment of FIGS. 1 and 2 which require attachment of brackets to a frame. Furthermore, it collapses such that all components lie approximately in a single plane for convenient storage. For example, the ladder 400 may be stored flat under or behind a seat in the cab of a tractor. Furthermore with minor modifications between embodiments, which must primarily address the tire size, the ladder 400 may work on virtually any vehicle of any size and model.

Turning now to FIG. 6 a perspective view of another engine compartment ladder 600, according to one exemplary embodiment, is shown. The ladder 600, similar to previous embodiments, comprises a platform 606 and a downward protrusion. In this embodiment, the platform 606 comprises a collapsible sliding member 602. Attached to the first end 626 of the platform 606 are universal brackets 608. The platform 606 is cantilevered away from and supported by the brackets 608. According to one exemplary embodiment, the brackets 608 and platform 606 are strong enough to support a user without additional support. The universal brackets 608 are configured to attach to virtually any structure that can bear the weight of a user. For example, the brackets 608 may be attached to the frame like previous embodiments or to body panels or a firewall in the engine compartment. The brackets 608 and platform 606 are attached together via rotatable joints (not shown). These joints may take a variety of configurations such as one similar to those shown in relation to FIGS. 1 and 2.

The sliding member 602 allows the platform 606 to collapse very easily to a very small size. The sliding member 602 slides along rollers and grooves mounted underneath the platform 606. Alternatively, the sliding member may also slide along a metal on metal tongue and groove feature.

Attached to the sliding member 602 of the platform 606 near the second end 628 is the downward protrusion that comprises rails 612 and a step 614. The rails 612 and step 614 are very similar to those shown in previous embodiments. However, the rails 612 are shorter than those previously shown and only support a single step 614. The shorter rails 612 allow the ladder 600 to be attached to the truck tractor at a lower height. Furthermore, the platform 606 and step 614 may be much smaller than shown in previous embodiments and operate more as steps to get up to the frame than as a standing area for working. Optionally, a handle may be mounted elsewhere on the body of a truck to be used in conjunction with the ladder 600.

The ladder 600 is collapsible similar to the previous embodiments. In addition, the sliding member 602 and only a single step 614 allow for an even simpler conversion between extended and collapsed positions. The step 614 and rails 612 can fold along joints 624 to collapse under the sliding member 602 of the platform 606. The platform 606 may then rotate along hinges (not shown) to a vertical position. When in the collapsed position the ladder 600 may allow an engine compartment cover to be closed.

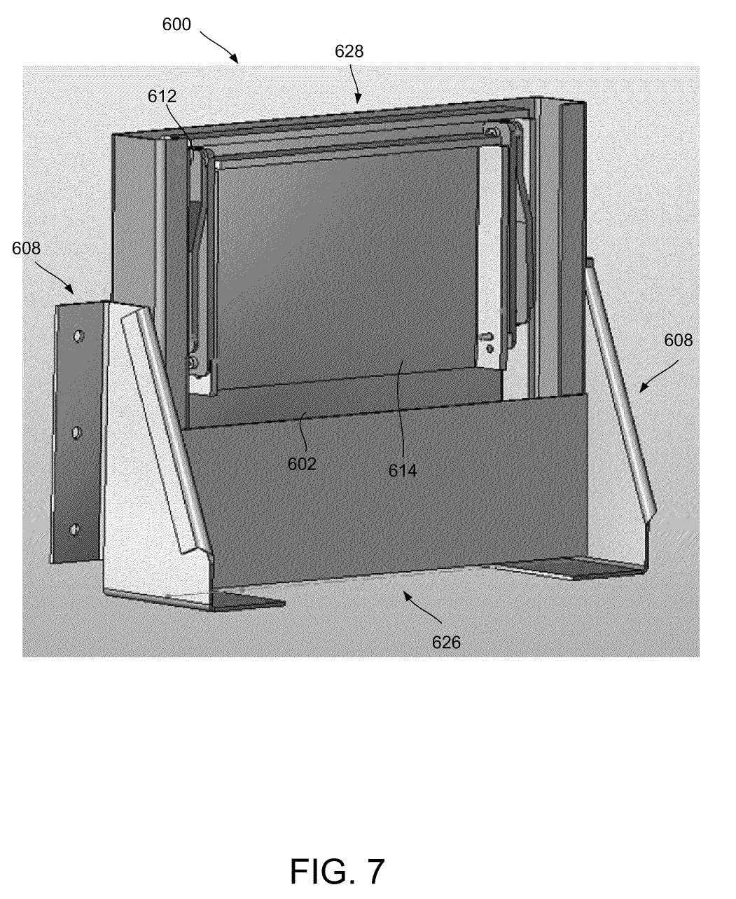

FIG. 7 is a perspective view of the engine compartment ladder 600 of FIG. 6 in collapsed position. The platform 606 is oriented vertically with the slidable member 602 retracted rather than extended as in FIG. 6. Underneath the slidable member is the step 614 and rails 612 which have been collapsed. In some embodiments sliding latches, similar to those shown in FIGS. 1 and 2, are used to hold the platform 606 in the desired position.

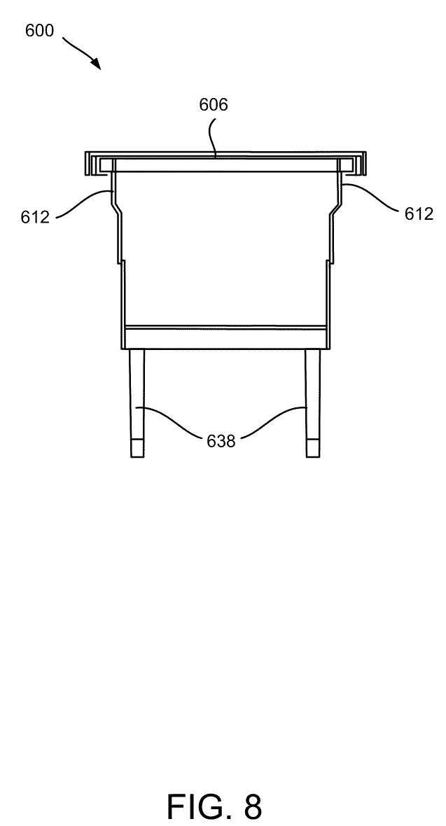

Similar to the previous embodiments, the ladder 600 is subject to considerable variation. For example, the ladder 600 in some embodiments may have more than one step. Additional supports, such as rail members (not shown) between the rails 612 and step 614 may provide additional strength. Alternatively, the step 614 may be supported by one or more legs against the ground. FIG. 8 illustrates legs attached to the step 614.

FIG. 8 shows an elevation front view of the engine compartment ladder of FIG. 6 with legs 638. The legs 638 may take a variety of forms. For example, the legs 38 may be attached to the step 614 via a joint which allows them to fold under the step. The legs may by extendable, similar to a telescope. Telescopic legs would have the advantage of being able to adjust to the height of the ground wherever a vehicle is placed. The use of legs 638 may allow the rails 612 to be made of less rigid material because the weight of a user could be primarily supported by the legs 638 rather than the rails 612 and platform 606. As will be clear to one skilled in the art, legs similar to those shown in FIG. 8 may be added to the previous embodiments of FIGS. 1-7 as well, without limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for supporting a user, the apparatus comprising:
a platform for supporting a user and for resting on a tire for support; and
a collapsible downward protrusion extending downward from the platform, the collapsible downward protrusion having one or more steps.

2. The apparatus of claim 1, wherein the downward protrusion further comprises a support member extending downward from the platform to engage an external surface for support.

3. The apparatus of claim 1, wherein the platform depth is sufficient to span the width of a tire.

4. The apparatus of claim 1, wherein the platform is substantially larger than the steps.

5. The apparatus of claim 1, wherein the downward protrusion is collapsible under the platform.

6. The apparatus of claim 1, wherein the downward protrusion is collapsible by means of one or more joints which allow the protrusion to fold against the platform.

7. The apparatus of claim 1, wherein the downward protrusion collapses to substantially within the dimensions of the platform.

8. The apparatus of claim 1, wherein the platform comprises a joint along which the platform can fold.

9. The apparatus of claim 1, wherein the platform comprises a slidable member.

10. The apparatus of claim 1, wherein the first end of the platform is configured to engage a frame of the vehicle for support.

11. The apparatus of claim 10, wherein the first end of the platform is configured to engage a frame of the vehicle via one or more hinges.

12. The apparatus of claim 1, wherein the downward protrusion is configured to engage a ground surface for support.

13. The apparatus of claim 1, wherein the downward protrusion is configured to engage one of a tire and a wheel of the vehicle for support.

14. The apparatus of claim 13, wherein a bumper extends from a handrail to engage one of the tire and the wheel of the vehicle.

15. The apparatus of claim 1, wherein the downward protrusion comprises a first rail and a second rail with the one or more steps extending between the first rail and the second rail.

16. The apparatus of claim 1, wherein the apparatus further comprises latches to selectively secure the platform in one of an extended or a collapsed position.

17. A system for supporting a user, the system comprising:
a vehicle comprising a tire and an elevated engine compartment;
an apparatus for supporting a user, the apparatus comprising:
a platform for supporting a user and for resting on the tire for support; and
a downward protrusion extending downward from the platform, the downward protrusion having one or more steps;
whereby a user may climb the apparatus using the one or more steps and the platform to gain access to the engine compartment of the vehicle.

18. The system of claim 17, wherein the downward protrusion is collapsible.

19. The system of claim 18, wherein the downward protrusion is collapsible by means of one or more joints which allow the protrusion to fold against the platform.

20. The system of claim 17, wherein the first end of the platform is configured to engage a frame of the vehicle for support.

21. The system of claim 20, wherein the first end of the platform is configured to engage a frame of the truck tractor via one or more hinges.

22. The system of claim 17, wherein the downward protrusion comprises a first rail and a second rail with the one or more steps extending between the first rail and the second rail.

23. An apparatus for supporting a user, the apparatus comprising:
a platform having a first end and a second end, wherein the first end is configured to attach to a structural component of the vehicle and wherein the platform comprises a slidable member; and
a downward protrusion attached to the second end, the downward protrusion having one or more steps, wherein the downward protrusion folds under the slidable member of the platform.

24. A method for providing access to an engine compartment of a vehicle, the method comprising:
providing a vehicle comprising a tire and an elevated engine compartment adjacent to the tire;
an apparatus for supporting a user, the apparatus comprising:
a platform for supporting a user and for resting on the tire for support; and
a collapsible downward protrusion extending downward from the platform, the collapsible downward protrusion having one or more steps;
placing the platform over the tire with the tire supporting the platform.

25. A method of claim 24, wherein the collapsible downward protrusion is in a collapsed position and the method further comprises:
converting the downward protrusion from the collapsed position to an extended position;
placing the platform over the tire with the tire supporting the platform, whereby a user may climb the steps to the platform to access the engine compartment; and
removing the platform from over the tire and converting the downward protrusion from the extended position to the collapsed position.
